(19) United States
(12) Patent Application Publication
(10) Pub. No.: US 2005/0104342 A1
(43) Pub. Date: May 19, 2005

(54) AN IMPROVED SIDE AIRBAG

(75) Inventors: Christianna R. Jackson, Livonia, MI (US); Tzu-Chen Weng, Troy, MI (US); Kirk David Arthurs, Newport, MI (US)

Correspondence Address: KEVIN G. MIERZWA;ARTZ & ARTZ, P.C., 28333 TELEGRAPH ROAD, SUITE 250, SOUTHFIELD, MI, 48034, US

(73) Assignee: FORD GLOBAL TECHNOLOGIES, LLC, Dearborn, MI (US)

(21) Appl. No.: 10/707,036

(22) Filed: Nov. 17, 2003

(51) Int. Cl. B60R 21/22

(52) U.S. Cl. 280/730.2

(57) ABSTRACT

An improved side airbag (10) is provided for enhancing protection of a vehicle occupant's thorax and simultaneously displacing the vehicle occupant (14) away from door intrusion. This improved side airbag (12) is an inflatable bag having a thorax-cushioning portion (16) and a pelvis-pushing portion (18) adjacent to the thorax-cushioning portion (16). The thorax-cushioning portion (16) has a first predetermined stiffness for cushioning a thorax region of the vehicle occupant (14) while the pelvis-pushing portion (18) has a second predetermined stiffness for displacing the vehicle occupant (14) away from the door intrusion. The second predetermined stiffness of the pelvis-pushing portion (18) is greater than the first predetermined stiffness of thorax-cushioning portion (16).

### BACKGROUND OF INVENTION

The present invention relates generally to supplemental restraint systems of vehicles, and more particularly to an improved side airbag for enhancing rib protection and safely moving the occupant away from door intrusion in a side collision.

Existing side airbags include various constructions for cushioning vehicle occupants during side collisions. A typical airbag construction is a single-chamber structure. As is known, this single-chamber structure typically provides a substantially uniform pressure or stiffness throughout the entire airbag.

A drawback of this single-chamber structure is that it usually does not distribute a larger portion of the impact force to parts of the occupant's body, which are better suited for withstanding those forces. For example, a single-chamber airbag can apply substantially the same force to both the occupant's pelvis and ribs. As a result, the occupant's ribs can be injured when his pelvis could have been safely used to receive some of the forces that were imparted upon his ribs.

Another kind of airbag construction is a dual-chamber structure, which typically requires that the airbag include two chambers that are in open communication with each other. This open communication may allow pressure to equalize throughout both chambers as the occupant is forced onto the airbag. For that reason, the dual-chamber structure can have disadvantages similar to those of the single-chamber structure. Namely, the dual-chamber structure may fail to distribute a greater portion of the impact force to more durable parts of the occupant's body.

Still another drawback of existing airbags is that they typically lack the structure for cushioning relatively fragile parts of the occupant's body and simultaneously displacing the occupant's body away from door intrusion.

Therefore, a need exists for an improved side airbag that enhances thorax protection and simultaneously moves the occupant's body away from door intrusion.

### SUMMARY OF INVENTION

The present invention provides an improved side airbag for enhancing protection of a vehicle occupant's thorax and displacing the vehicle occupant away from door intrusion. This improved airbag is an inflatable bag having a thorax-cushioning portion and a pelvis-pushing portion adjacent to the thorax-cushioning portion. The thorax-cushioning portion has a first predetermined stiffness for cushioning a thorax region of the vehicle occupant while the pelvis-pushing portion has a second predetermined stiffness for displacing the vehicle occupant away from the door intrusion. The second predetermined stiffness of the pelvis-pushing portion is greater than the first predetermined stiffness of thorax-cushioning portion.

One advantage of the present invention is that an improved side airbag is provided that is sufficiently stiff for cushioning a vehicle occupant's thorax without causing injury to the occupant's thorax.

Another advantage of the present invention is that an improved side airbag is provided that is sufficiently stiff for safely contacting a vehicle occupant and moving him away from door intrusion.

Yet another advantage of the present invention is that an improved airbag is provided having a simple construction for minimizing the manufacturing cycle time and costs associated therewith.

Other advantages of the present invention will become apparent upon considering the following detailed description and appended claims, and upon reference to the accompanying drawings.

### BRIEF DESCRIPTION OF DRAWINGS

For a more complete understanding of this invention, reference should now be made to the embodiments illustrated in greater detail in the accompanying drawings and described below by way of the examples of the invention:

FIG. 1A is a side cutaway view of a vehicle with an improved side airbag, according to one embodiment of the present invention.

FIG. 1B is a front cutaway view of the vehicle with the improved side airbag shown in FIG. 1A.

FIG. 2 is a perspective view of the improved side airbag shown in FIG. 1A.

FIG. 3 is an exploded view of the improved side airbag shown in FIG. 2, illustrating the improved side airbag being comprised of a first outer panel, a second outer panel, an inner panel, and an intake manifold, according to one embodiment of the invention.

FIG. 4 is a cross-sectional view of the improved side airbag shown in FIG. 2.

FIG. 5 is an exploded view of the improved side airbag shown in FIG. 2, illustrating the improved side airbag being comprised of a one panel and an intake manifold, according to another embodiment of the invention; and.

FIGS. 6A-6D are perspective views of the panel shown in FIG. 5, illustrating the sequential manipulation of the panel for creating the improved side airbag.

### DETAILED DESCRIPTION

In the following figures, the same reference numerals are used to identify the same components in the various views.

The present invention is particularly suited for an improved side airbag having multiple cloth panels for protecting a front seat passenger in a side collision. In this regard, the embodiments described herein employ structural features where the context permits. However, it is understood that a variety of other embodiments without the described features are contemplated as well. For example, the improved side airbag can instead include only one cloth panel and be utilized for protecting various occupants in a variety of different collisions. For this reason, it follows that the invention can be carried out in various other modes and utilized for other suitable applications as desired.

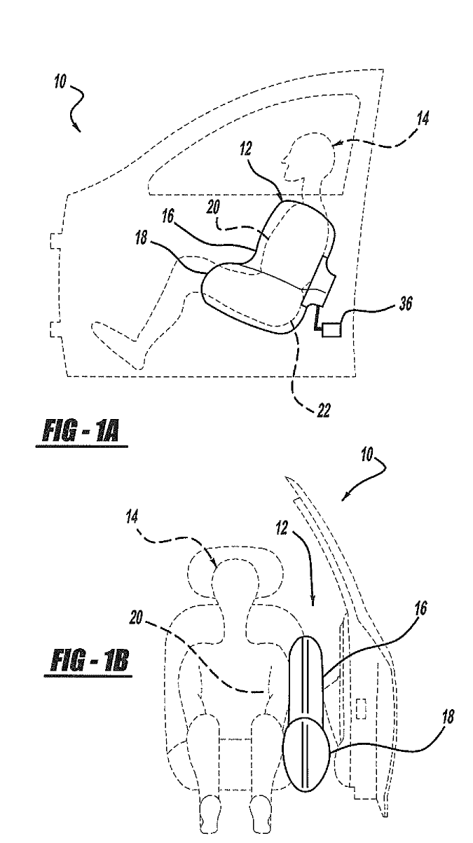

Referring to FIGS. 1A and 1B, there are shown front and side cutaway views of a vehicle 10 with a fully-deployed improved side airbag 12, according to one embodiment of the invention. This improved side airbag 12 is intended to cushion an occupant 14 and simultaneously move him away from door intrusion. To that end, the airbag 12 includes two or more portions that vary in stiffness.

Specifically, in one embodiment, the improved side airbag 12 has a bifurcated construction with a thorax-cushioning portion 16 and a pelvis-pushing portion 18 that is adjacent to the thorax-cushioning portion 16. The thorax-cushioning portion 16 is sufficiently stiff for cushioning the occupant's ribs 20 and other relatively fragile thorax regions. For example, the thorax-cushioning portion 16 of the airbag 12 can be pressurized to about fifteen (15) psi when the occupant's thorax presses into that portion 16 of the airbag 12. However, it will be appreciated that the thorax-cushioning portion 16 can be pressurized to various other suitable pressure levels as desired.

Moreover, the pelvis-pushing portion 18 is sufficiently stiff for contacting the occupant's pelvis 22 and moving him away from door intrusion. For example, the pelvis-pushing portion 18 of the airbag 12 can be pressurized to about thirty (30) psi when that portion 18 of the airbag 12 contacts the occupant and moves him away from the door. On the other hand, it is contemplated that the pelvis-pushing portion 18 can instead be pressurized to a variety of other suitable pressure levels.

It can be seen that this construction requires that the pelvis-pushing portion 18 is substantially stiffer than the thorax-cushioning portion 16. These features allow the improved airbag 12 to apply a greater portion of the impact forces to the occupant's pelvis 22 and lower body region. It is understood that the occupant's pelvis and lower body region typically are more durable and better suited to receive greater forces than the occupant's ribs and other relatively fragile thorax regions. In that regard, the varying stiffness of the improved side airbag 12 can protect the occupant's thorax area and safely move him away from door intrusion.

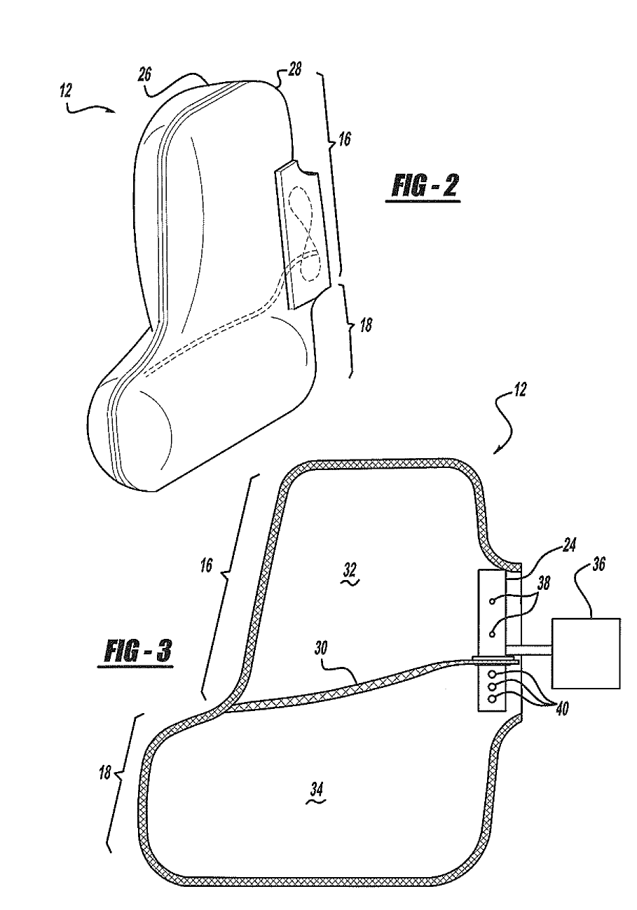

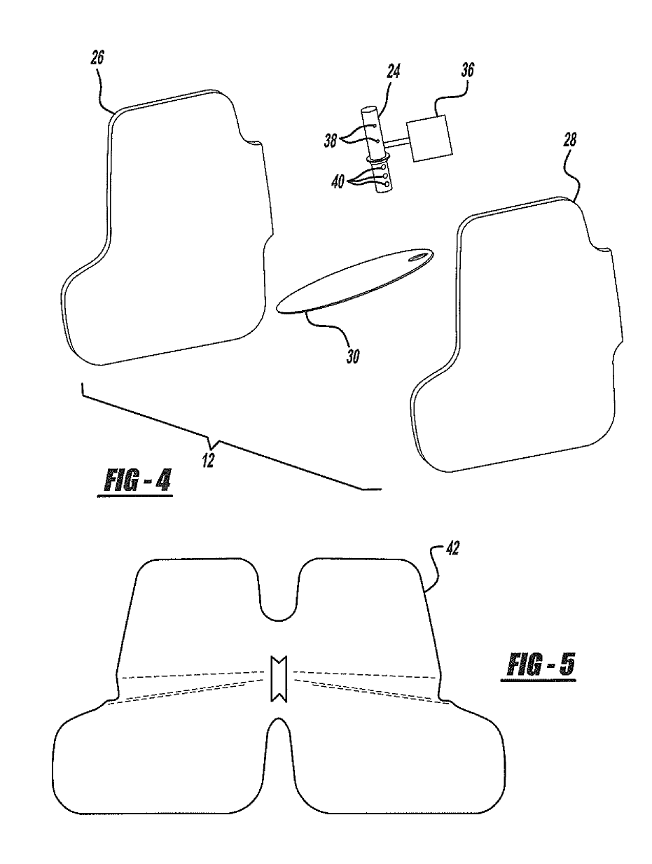

Referring now to FIGS. 2-4, the improved side airbag 12 is constructed of three cloth panels and an inflator manifold 24. Specifically, as best shown in FIG. 3, the improved side airbag 12 includes a first outer panel 26 and a second outer panel 28 that is sized substantially similar to the first outer panel 26. The first and second outer panels 26, 28 are sewn or otherwise attached to each other at their peripheries. Furthermore, as best shown in FIG. 4, the first and second outer panels 26, 28 have the inner panel 30 attached thereto and in connection therebetween. In this regard, the inner panel 30 completely divides the interior of the improved side airbag 12 into a first chamber 32 and a second chamber 34.

The first and second chambers 32, 34 are respectively utilized for providing stiffness to the thorax-cushioning portion 16 and the pelvis-pushing portion 18. These chambers 32, 34 are isolated from each other and therefore are not in open communication with each other. In that regard, gas within each chamber does not pass to the other chamber. Each of these chambers 32, 34 receives gas directly from a portion of the intake manifold 24. This intake manifold 24 is coupled to an inflator device 36 and includes two sets of openings for injecting gas into each chamber 32, 34.

Specifically, the intake manifold 24 includes a first series of openings 38 for injecting gas into the first chamber 32 and a second series of openings 40 for injecting gas into the second chamber 34. The quantity and the size of each set of openings 38, 40, determine a composite opening area through which gas flows into the respective chambers 32, 34. This composite opening area likewise determines the rate by which gas is injected into the respective chambers 32, 34. For example, the second chamber 34 can be coupled to a portion of the intake manifold 24 that has openings 40 sized substantially larger than the openings 38 utilized for injecting gas into the first chamber 32. Alternatively, the second chamber 34 can be coupled to a portion of intake manifold 24 that has substantially more openings 40 than the number of similarly sized openings 38 utilized to inject gas into the first chamber 32. In this way, the second chamber 34 and the pelvis-pushing portion 18 can be substantially stiffer than the thorax-cushioning portion 16.

These openings and the continuous injection of gas prevents the gas from back-flowing from one chamber through the intake manifold 24 into another chamber. In this respect, the pelvis-pushing portion 18 can be compressed without causing gas to flow from the second chamber 34 through the intake manifold 24 into the first chamber 32 and thereby increase the stiffness of the thorax-cushioning portion 16.

Additionally, the size of the chambers 32, 34 also determines the pressure of gas within those chambers 32, 34 and the stiffness of the respective airbag portions 16, 18. Specifically, a smaller-volume chamber, which receives gas at a similar or greater rate than a larger-volume chamber, can be more pressurized than the larger-volume chamber. In this regard, the second chamber 34 can be sized smaller in volume than the first chamber 32 and allow the pelvis-pushing portion 18 to be stiffer than the thorax-cushioning portion 16.

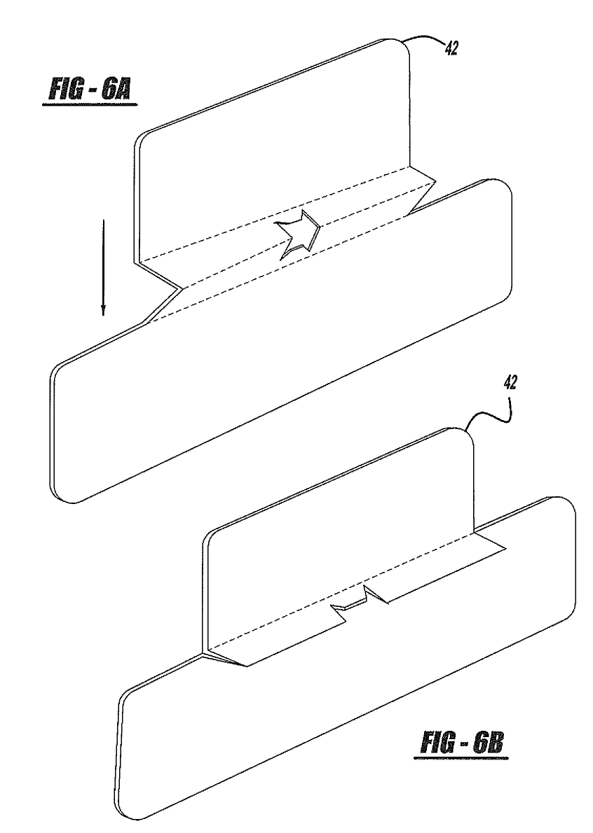

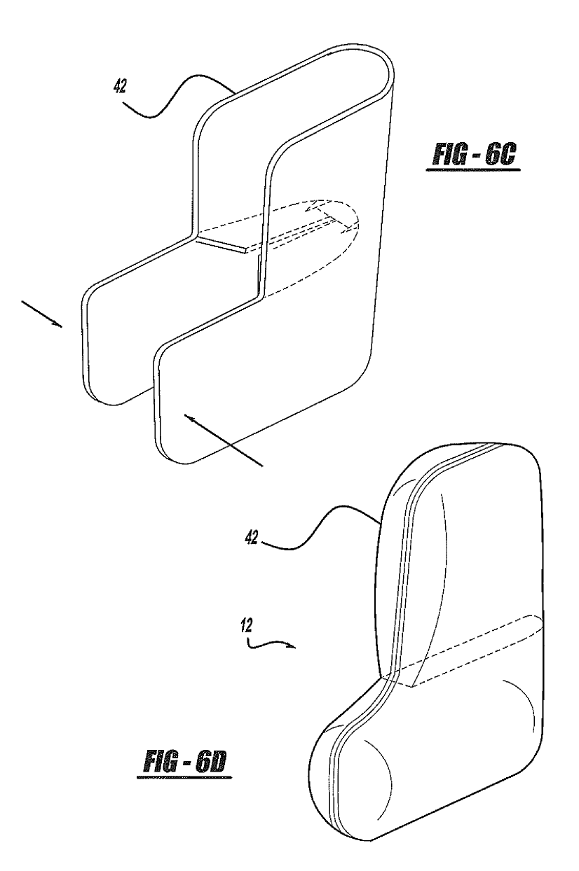

Referring now to FIGS. 5 and 6A-6D, it will be appreciated that the improved side airbag 12 can be constructed of more or less than three cloth panels as desired. Specifically, these figures show that the improved side airbag 12 can be constructed of one panel, according to another embodiment of the invention. As best illustrated in the sequence shown in FIGS. 6A-6D, a single panel 42 of cloth can be folded and sewn to create the device illustrated in FIG. 2.

While particular embodiments of the invention have been shown and described, it will be understood, of course, that the invention is not limited thereto since modifications may be made by those skilled in the art, particularly in light of the foregoing teachings. Accordingly, it is intended that the invention be limited only in terms of the appended claims.

1. An improved side airbag for enhancing thorax protection and displacing a vehicle occupant away from a door intrusion, comprising:
an inflatable bag having a thorax-cushioning portion and a pelvis-pushing portion adjacent to said thorax-cushioning portion, said thorax-cushioning portion having a first predetermined stiffness for cushioning a thorax region of the vehicle occupant, said pelvis-pushing portion having a second predetermined stiffness for displacing the vehicle occupant away from the door intrusion;
wherein said second predetermined stiffness is greater than said first predetermined stiffness.

2. The improved side airbag as recited in claim 1 wherein said thorax-cushioning portion defines a first chamber of the improved side airbag for containing a first gas volume, said pelvis-pushing portion defines a second chamber of the improved side airbag for containing a second gas volume, said first gas volume and said second gas volume remaining separate and respectively within said first chamber and said second chamber.

3. The improved side airbag of claim 2 wherein said second gas volume within said second chamber of said pelvis-pushing portion is more pressurized than said first gas volume within said first chamber of said thorax-cushioning portion.

4. The improved side airbag of claim 3 wherein said second chamber is sized smaller than said first chamber.

5. The improved side airbag of claim 3 wherein said thorax-cushioning portion and said pelvis-pushing portion have an inflator manifold coupled thereto, said inflator manifold including at least one first opening for supplying said first gas volume to said thorax-cushioning portion, said inflator manifold further including at least one second opening for supplying said second gas volume to said pelvis-pushing portion.

6. The improved side airbag of claim 5 wherein said at least one second opening is sized larger than said at least one first opening.

7. The improved side airbag of claim 5 wherein said at least one second opening is greater in quantity than said at least one first opening.

8. An improved side airbag for enhancing thorax protection and displacing a vehicle occupant away from a door intrusion, comprising:
an inflatable bag having at least one panel configured for defining a thorax-cushioning portion and a pelvis-pushing portion adjacent to said thorax-cushioning portion, said thorax-cushioning portion having a first predetermined stiffness for cushioning a thorax region of the vehicle occupant, said pelvis-pushing portion having a second predetermined stiffness for displacing the vehicle occupant away from the door intrusion;
wherein said second predetermined stiffness is greater than said first predetermined stiffness.

9. The improved side airbag as recited in claim 7 wherein said at least one panel defines said thorax-cushioning portion having a first chamber for containing a first gas volume, said at least one panel defining said pelvis-pushing portion having a second chamber for containing a second gas volume, said first gas volume and said second gas volume remaining separate and respectively within said first chamber and said second chamber.

10. The improved side airbag of claim 9 wherein said second gas volume within said second chamber of said pelvis-pushing portion is more pressurized than said first gas volume within said first chamber of said thorax-cushioning portion.

11. The improved side airbag of claim 10 wherein said second chamber is sized smaller than said first chamber.

12. The improved side airbag of claim 10 wherein said thorax-cushioning portion and said pelvis-pushing portion have an inflator manifold coupled thereto, said inflator manifold including at least one first opening for supplying said first gas volume to said thorax-cushioning portion, said inflator manifold further including at least one second opening for supplying said second gas volume to said pelvis-pushing portion.

13. The improved side airbag of claim 12 wherein said at least one second opening is sized larger than said at least one first opening.

14. The improved side airbag of claim 12 wherein said at least one second opening is greater in quantity than said at least one first opening.

15. An improved side airbag for enhancing thorax protection and displacing a vehicle occupant away from a door intrusion, comprising:
an inflatable bag having a first outer panel, a second outer panel coupled to said first outer panel and sized substantially similar to said first outer panel, and an inner panel attached to and in connection between said first and second outer panels;
wherein said first outer panel, said second outer panel, and said inner panel are configured for defining a thorax-cushioning portion and a pelvis-pushing portion that is adjacent to said thorax-cushioning portion;
wherein said thorax-cushioning portion has a first predetermined stiffness for cushioning a thorax region of the vehicle occupant, said pelvis-pushing portion having a second predetermined stiffness for displacing the vehicle occupant away from the door intrusion;
wherein said second predetermined stiffness is greater than said first predetermined stiffness.

16. The improved side airbag as recited in claim 15 wherein said thorax-cushioning portion includes a first chamber for containing a first gas volume, said pelvis-pushing portion having a second chamber for containing a second gas volume, said first gas volume and said second gas volume remaining separate and respectively within said first chamber and said second chamber.

17. The improved side airbag of claim 16 wherein said second gas volume within said second chamber of said pelvis-pushing portion is more pressurized than said first gas volume within said first chamber of said thorax-cushioning portion.

18. The improved side airbag of claim 15 wherein said second chamber is sized smaller than said first chamber.

19. The improved side airbag of claim 10 wherein said thorax-cushioning portion and said pelvis-pushing portion have an inflator manifold coupled thereto, said inflator manifold including at least one first opening for supplying said first gas volume to said thorax-cushioning portion, said inflator manifold further including at least one second opening for supplying said second gas volume to said pelvis-pushing portion, said at least one second opening being sized larger than said at least one first opening.

20. The improved side airbag of claim 10 wherein said thorax-cushioning portion and said pelvis-pushing portion have a inflator manifold coupled thereto, said inflator manifold including at least one first opening for supplying said first gas volume to said thorax-cushioning portion, said inflator manifold further including at least one second opening for supplying said second gas volume to said pelvis-pushing portion, said at least one second opening being greater in quantity than said at least one first opening.
